(19) United States
(12) Patent Application Publication
(10) Pub. No.: US 2024/0376005 A1
(43) Pub. Date: Nov. 14, 2024

(54) ADDITIVE COMPOSITION FOR STRENGTH ENHANCEMENT OF CEMENTITIOUS COMPOSITIONS

(71) Applicant: GCP Applied Technologies Inc., Alpharetta, GA (US)

(72) Inventors: Jeffrey J. THOMAS, Winchester, MA (US); Josephine H. CHEUNG, Lexington, MA (US); Joshua DETELLIS, Framingham, MA (US)

(21) Appl. No.: 18/658,709

(22) Filed: May 8, 2024

(30) Foreign Application Priority Data
May 9, 2023 (FR) FR2304584

(51) Int. Cl. C04B 24/12; C04B 14/06; C04B 14/28; C04B 22/00; C04B 24/06; C04B 24/10; C04B 24/26; C04B 28/04; C04B 103/12; C04B 103/22

(52) U.S. Cl. CPC C04B 24/122; C04B 14/06; C04B 14/28; C04B 22/00; C04B 24/06; C04B 24/10; C04B 24/2641; C04B 28/04; C04B 2103/12; C04B 2103/22; C04B 2201/50

(57) ABSTRACT

A composition for use as an additive for enhancing the strength of a cementitious composition, the composition comprising an alkanolamine comprising ethanoldiisopropanolamine (EDIPA) and optionally at least one selected from the group consisting of triisopropanolamine (TIPA), diethanolisopropanolamine (DEIPA), triethanol amine (TEA), and tetrakis-(2-hydroxyethyl)ethylenediamine (THEED); at least one set retarder selected from the group consisting of a gluconate salt, sucrose, corn syrup, and molasses; and at least one set accelerator selected from the group consisting of a thiocyanate salt, sodium chloride, and calcium chloride, wherein the alkanolamine and the set accelerator are present at a mass ratio of from 0.2 to 4.0 and the set accelerator and the set retarder are present at a mass ratio of from 1 to 10. The additive enhances the short term and long-term strength of cement when hydrated.

### BACKGROUND OF THE INVENTION

The present invention relates to additive compositions for enhancing the strength of cementitious compositions. In particular, the present invention relates to the use of the disclosed additive compositions in cementitious compositions such that the early and late age compressive strength of the cement when cured is improved relative to a cement composition without the disclosed additive compositions.

The term cement is used to designate many different kinds of materials useful as binders or adhesives. Hydraulic cements are powdered materials which, when mixed with water, form a “paste” that hardens slowly. If further mixed with sand it forms a “mortar” and if mixed with sand and coarse aggregate, such as rock, it forms a “concrete” which are rock-hard products. These products are commonly referred to as hydraulic cement mixes. Portland cement is distinguished from other cements by the different components of which it is composed, and the requirement that it meet particular standard specifications established in each country. For example, in the United States, the American Society for Testing and Materials (ASTM), American Association of State Highway and Transportation Officials, as well as other government agencies, have set certain basic standards for cement which are based on principal chemical composition requirements of the clinker and principal physical property requirements of the final hardened mortar or concrete. For purposes of this disclosure the term “Portland cement” is intended to include all cementitious compositions that meet the requirements of the ASTM (as designated by ASTM Specification C150), or the established standards of other countries. Portland cement clinker is prepared by sintering a mixture of components including calcium carbonate (as limestone), aluminum silicate (as clay or shale), silicon dioxide (as sand) and miscellaneous iron oxides. During the sintering process, chemical reactions take place wherein hardened nodules, commonly called clinkers, are formed. Portland cement clinker is formed by the high-temperature reaction of raw materials containing calcium, silicon, aluminum, and iron to give primarily tricalcium silicate, dicalcium silicate, tricalcium aluminate, and a ferrite solid solution phase approximating tetracalcium aluminoferrite.

After the clinker has cooled, it is ground into a fine powder together with a small amount of gypsum (calcium sulfate) in a finish grinding mill to provide a fine, homogeneous powder product, known as Portland cement. Grinding of the clinker and other components of the cement into a fine powder is the last step in the cement production process. There are two broad purposes to the use of a cement additive during grinding. One is to improve the grinding process to make it more efficient. Such improvements can be quantified as, for example, reduced grinding time, reduced grinding energy, and increased production rate. The second broad purpose is to improve or change the performance of the cement when it is used to make concrete. In this case, the chemicals remain on the surface of the ground cement particles until the cement is mixed with water, at which point they modify the cement hydration process, often by first redissolving into the mix water. While there are many performance changes that can be achieved with cement additives, a particularly common and desirable attribute is an increase in the compressive strength at various (or all) ages. In general, cement additives that improve concrete performance also improve the grinding efficiency. They therefore represent a higher performing (and more expensive) class of cement additives (known as quality improvers) compared to additives that only affect the grinding process.

Due to the hardness of the clinkers, a large amount of energy is required to properly mill them into a suitable powder form. Energy requirements for finish grinding can vary from about 33 to 77 KW h/ton depending upon the nature of the clinker. Several materials such as glycols, alkanolamines, amine acetates, aromatic acetates, etc., have been shown to reduce the amount of energy required and thereby improve the efficiency of the grinding of the hard clinkers. These materials, commonly known as “grinding aids” or “grinding additives.” are processing additives which are introduced into the mill in small dosages and interground with the clinker to attain a uniform powdery mixture. In addition to reducing grinding energy, the commonly used processing additives listed above are frequently used to improve the ability of the powder to flow easily and reduce its tendency to form lumps during storage.

Some cement additive compositions can be used to improve or change the performance of the cement when it is used to make concrete. Similarly, chemicals for enhancing strength can also be added when concrete is being mixed. Typically, the chemicals will be added to the mix water when the ingredients of the concrete are being combined.

Because of the very high temperature processing required to form suitable Portland cement clinker, clinker becomes a relatively expensive and carbon-intensive raw material. For certain applications, it is possible to substitute less expensive fillers such as limestone or clinker substitutes such as granulated blast furnace slags, natural or artificial pozzolan, calcined clay, pulverized fuel ash, and the like, for a portion of the clinker. As used herein, the term filler refers to an inert material that has no later age strength enhancing attributes; the term “clinker substitute” refers to a material that may contribute to long term compressive strength enhancement beyond 28 days. The addition of these fillers or clinker substitutes to form “blended cements” is limited in practice by the fact that such addition usually results in a diminution in the physical strength properties of the resultant cement. For example, when a filler such as limestone is blended in amounts greater than 5%, the resultant cement exhibits a marked reduction in strength, particularly with respect to the strength attained after 28 days of moist curing (28-day strength). As used herein, the term “blended cements” or “cementitious compositions” refers to hydraulic cement compositions containing between 2 and 90% more conventionally between 5 and 60%, fillers or clinker substitute materials.

Reducing the amount of clinker in concrete (known as the “clinker factor”) is currently the most effective way to reduce the CO₂ footprint of concrete. This is because most of the CO₂ associated with the use of concrete is emitted during the manufacture of the clinker in high-temperature kilns. Recently, an increase in the demand for strength-increasing cement additives has been noticed, driven by regulations aimed at limiting CO₂ emissions.

Various other additives may be added to cement to alter the physical properties of the final cement. For example, alkanolamines such as monoethanolamine, diethanolamine, triethanolamine and the like are known to shorten the set time (set accelerators) as well as enhance the one-day compressive strength (early strength) of cements. These additives, however, have little beneficial effect on the 28-day set strength of the finished cement and in some cases may actually diminish it. This behavior is described by V. Dodson, in “Concrete Admixtures”, Van Reinhold, New York, 1990, who states that calcium chloride, the best known set-time accelerator and early-age strength enhancer reduces compressive strengths at later-ages.

U.S. Pat. Nos. 4,990,190, 5,017,234, 5,084,103, 6,048,393 and 6,290,772 the disclosures of which are hereby incorporated by reference, describe the finding that certain higher trihydroxyalkylamines such as triisopropanolamine (hereinafter referred to as “TIPA”) and N, N-bis (2-hydroxyethyl)-2-hydroxypropylamine (hereinafter referred to as “DEIPA”) will improve the late strength (strength after 7 and 28 days of preparation of the wet cement mix) of Portland cement, especially Portland cements containing at least 4 percent C₄AF. The strength-enhancing higher trihydroxyalkylamine additives described in these patents are said to be particularly useful in blended cements. For example, TIPA was found to improve the late strength properties of cement compositions more so than the early strength. More surprising is the observation that it tends to increase the amount of air entrained in the cement. In order to improve the early strength, setting and air entrainment properties of set cement composition containing TIPA, the prior art taught the incorporation of known early-strength enhancers and setting accelerators, such as TEA or alkali metal salts, and known air detraining agent (ADA), such as those illustrated in U.S. Pat. No. 5,156,679.

Such strength enhancing compositions, however, should not significantly shorten or lengthen the set time of the concrete. Accordingly, there remains a need for additive compositions that improve strength properties at both early and late stages to a greater degree than is currently possible, in order to reduce the clinker content of concrete as much as possible, without significantly affecting the set time of the concrete to which the strength enhancing composition has been added.

### BRIEF SUMMARY OF THE INVENTION

In one aspect, disclosed herein is a composition for use as an additive for enhancing the strength of a cementitious composition, the composition comprising: an alkanolamine comprising ethanoldiisopropanolamine (EDIPA) and optionally at least one selected from the group consisting of triisopropanolamine (TIPA), diethanolisopropanolamine (DEIPA), triethanolamine (TEA), and tetrakis-(2-hydroxyethyl)ethylenediamine (THEED): at least one set retarder selected from the group consisting of a gluconate salt, sucrose, corn syrup, and molasses; and at least one set accelerator selected from the group consisting of a thiocyanate salt, sodium chloride, and calcium chloride, wherein the alkanolamine and the set accelerator are present at a mass ratio of from 0.2 to 4.0 and the set accelerator and the set retarder are present at a mass ratio of from 1 to 10.

In another aspect, disclosed herein is a method of enhancing the strength of a cement composition, the method comprising the steps of: (i) grinding a solid comprising Portland cement clinker in the presence of an additive thereby preparing the cement composition, or (ii) making concrete from a mixture of a solid comprising Portland cement clinker, sand, coarse aggregate, water, and an additive, wherein the additive comprises: an alkanolamine comprising ethanoldiisopropanolamine (EDIPA) and optionally at least one selected from the group consisting of triisopropanolamine (TIPA), diethanolisopropanolamine (DEIPA), triethanolamine (TEA), and tetrakis-(2-hydroxyethyl)ethylenediamine (THEED): at least one set retarder selected from the group consisting of a gluconate salt, sucrose, corn syrup, and molasses; and at least one set accelerator selected from the group consisting of a thiocyanate salt, sodium chloride, and calcium chloride, wherein the alkanolamine and the set accelerator are present at a mass ratio of from 0.2 to 4.0 and the set accelerator and the set retarder are present at a mass ratio of from 1 to 10, and wherein the cement composition, when cured, has a compressive strength at 2 days and at 28 days that is at least 10% higher than a cement composition without the additive.

In yet another aspect, disclosed herein is a strength-enhanced hydraulic cement powder composition comprising Portland cement clinker and an additive, wherein the additive comprises: an alkanolamine comprising ethanoldiisopropanolamine (EDIPA) and optionally at least one selected from the group consisting of triisopropanolamine (TIPA), diethanolisopropanolamine (DEIPA), triethanolamine (TEA), and tetrakis-(2-hydroxyethyl)ethylenediamine (THEED); at least one set retarder selected from the group consisting of a gluconate salt, sucrose, corn syrup, and molasses; and at least one set accelerator selected from the group consisting of a thiocyanate salt, sodium chloride, and calcium chloride, wherein the alkanolamine and the set accelerator are present at a mass ratio of from 0.2 to 4.0 and the set accelerator and the set retarder are present at a mass ratio of from 1 to 10.

In yet another aspect, disclosed herein is a hydraulic Portland cement composition comprising; from 20 to 64 percent by mass of clinker; from 5 to 60 percent by mass of calcined clay; from ( ) to 35 percent by mass of limestone; from 0 to 10 percent by mass of calcium sulfate; an additive comprising; an alkanolamine comprising ethanoldiisopropanolamine (EDIPA) and optionally at least one selected from the group consisting of triisopropanolamine (TIPA), diethanolisopropanolamine (DEIPA), triethanolamine (TEA), and tetrakis-(2-hydroxyethyl)ethylenediamine (THEED); at least one set retarder selected from the group consisting of a gluconate salt, sucrose, corn syrup, and molasses; and at least one set accelerator selected from the group consisting of a thiocyanate salt, sodium chloride, and calcium chloride, wherein the alkanolamine and the set accelerator are present at a mass ratio of from 0.2 to 4.0 and the set accelerator and the set retarder are present at a mass ratio of from 1 to 10.

In yet another aspect, disclosed herein is a cementitious composition comprising: cement; and a means for increasing the strength of the cementitious composition upon hardening the cementitious composition in an aqueous environment without substantially increasing set time of the cementitious composition.

The embodiments and features of the present invention can be used alone or in combinations with each other.

### BRIEF DESCRIPTION OF THE DRAWINGS

The foregoing will be apparent from the following more particular description of example embodiments of the invention, as illustrated in the accompanying drawings.

FIG. 1A is a graph showing the day 1 mortar strength results of as-received North American commercial cements with no added limestone with and without additives EXP-1 and EXP-2 normalized to the strength of the blank with no additive:

FIG. 1B is a graph showing the day 2 mortar strength results of as-received North American commercial cements with no added limestone with and without additives EXP-1 and EXP-2 normalized to the strength of the blank with no additive:

FIG. 1C is a graph showing the day 28 mortar strength results of as-received North American commercial cements with no added limestone with and without additives EXP-1 and EXP-2 normalized to the strength of the blank with no additive:

FIG. 1D is a graph showing the set time changes of various North American commercial cements with no added limestone with the additives EXP-1 and EXP-2 as compared to the blank cement with no additive:

FIG. 1E is a graph showing the day 1 mortar strength results of as-received North American commercial cements with limestone added to 22% by weight with and without additives EXP-1 and EXP-2 normalized to the strength of the blank with no additive:

FIG. 1F is a graph showing the day 2 mortar strength results of as-received North American commercial cements with limestone added to 22% by weight with and without additives EXP-1 and EXP-2 normalized to the strength of the blank with no additive:

FIG. 1G is a graph showing the day 28 mortar strength results of as-received North American commercial cements with limestone added to 22% by weight with and without additives EXP-1 and EXP-2 normalized to the strength of the blank with no additive:

FIG. 1H is a graph showing the set time changes of various North American commercial cements with limestone added to 22% with the additives EXP-1 and EXP-2 as compared to the blank cement with no additive;

FIG. 2 is an isothermal calorimetry graph illustrating the estimation of the initial set time of cement composition S7 as received and with an additive:

FIG. 3A is a circle graph showing the day 1 strength of cement S2 resulting from variations of the ratios of components of an additive as disclosed herein, wherein the size of the circle is proportional to the change from the blank:

FIG. 3B is a circle graph showing the day 2 strength of cement S2 resulting from variations of the ratios of components of an additive as disclosed herein, wherein the size of the circle is proportional to the change from the blank:

FIG. 3C is a circle graph showing the day 28 strength of cement S2 resulting from variations of the ratios of components of the additive as disclosed herein, wherein the size of the circle is proportional to the change from the blank:

FIG. 3D is a circle graph showing the set time changes of cement S2 resulting from variations of the ratios of components of an additive as disclosed herein, wherein the size of the circle is proportional to the change from the blank:

FIG. 4A is a graph of the isothermal calorimetry results for cement S1 prepared for strength testing and comparing the effects of the additives EXP-1 and EXP-2:

FIG. 4B is a graph of the isothermal calorimetry results for cement S2 prepared for strength testing and comparing the effects of the additives EXP-1 and EXP-2:

FIG. 4C is a graph of the isothermal calorimetry results for cement S3 prepared for strength testing and comparing the effects of the additives EXP-1 and EXP-2:

FIG. 4D is a graph of the isothermal calorimetry results for cement S4 prepared for strength testing and comparing the effects of the additives EXP-1 and EXP-2;

FIG. 4E is a graph of the isothermal calorimetry results for cement S5 prepared for strength testing and comparing the effects of the additives EXP-1 and EXP-2;

FIG. 4F is a graph of the isothermal calorimetry results for cement S6 prepared for strength testing and comparing the effects of the additives EXP-1 and EXP-2:

FIG. 4G is a graph of the isothermal calorimetry results for cement S7 prepared for strength testing and comparing the effects of the additives EXP-1 and EXP-2; and

FIG. 4H is a graph of the isothermal calorimetry results for cement S8 prepared for strength testing and comparing the effects of the additives EXP-1 and EXP-2.

### DETAILED DESCRIPTION OF THE INVENTION

As used herein, the terms “a”, “an”, “the” and the like refer to both the singular and plural unless the context clearly indicates otherwise. “A bottle”, for example, refers to a single bottle or more than one bottle.

Also as used herein, the description of one or more method steps does not preclude the presence of additional method steps before or after the combined recited steps. Additional steps may also be intervening steps to those described. In addition, it is understood that the lettering of process steps or ingredients is a convenient means for identifying discrete activities or ingredients and the recited lettering can be arranged in any sequence.

Where a range of numbers is presented in the application, it is understood that the range includes all integers and fractions thereof between the stated range limits. A range of numbers expressly includes numbers less than the stated endpoints and those in-between the stated range. A range of from 1-3, for example, includes the integers one, two, and three as well as any fractions that reside between these integers.

The conventional cement chemist's notation uses the following abbreviations:
CaO=C
SiO₂=S
Al₂O₃=A
Fe₂O₃=F

Under this notation, the following abbreviations are used:
tricalcium silicate=C₃S
dicalcium silicate=C₂S
tricalcium aluminate=C₃A
tetracalcium aluminoferrite=C₄AF

As used herein, “alkyl” means an optionally substituted saturated aliphatic branched or straight-chain monovalent hydrocarbon radical having the specified number of carbon atoms. Thus, “(C₁-C₄) alkyl” means a radical having from 1-4 carbon atoms in a linear or branched arrangement. “(C₁-C₄) alkyl” includes methyl, ethyl, propyl, isopropyl, n-butyl and tert-butyl.

As used herein, “alkanolamine” means an alkyl, typically a C₁-C₆ alkyl, functionalized with at least one amino group and at least one hydroxyl group. A “tertiary alkanolamine” includes an amino group in which all three hydrogens are replaced with a substituent, typically, an optionally substituted C₁-C₆ alkyl and at least one hydroxyl group for each alkyl group.

As used herein, “sucrose” refers to a disaccharide combination of the monosaccharide's glucose and fructose with the formula C₁₂H₂₂O₁₁.

As used herein, “corn syrup” refers to syrup made from cornstarch, consisting of dextrose, maltose, and dextrins.

As used herein, “molasses” refers to thick, dark brown syrup obtained from raw sugar during the refining process.

As used herein, a “chloride salt” refers to an alkali metal (Group I of the periodic table, e.g., sodium or potassium) or an alkali-earth (Group II of the periodic table, e.g., calcium) salts of hydrochloric acid.

As used herein, “thiocyanate salts” refers to an alkali metal (Group I of the periodic table, e.g., sodium or potassium) or an alkali-earth (Group II of the periodic table, e.g., calcium) salts of thiocyanic acid.

The content of all components in the compositions described below is indicated relative to the dry weight of the composition.

The terms “cement composition” or “cementitious powder” are used herein to designate a binder or an adhesive that includes a material that will solidify upon addition of water (hydraulic cementitious material), and an optional additive. When mixed with water and sand, hydraulic cementitious materials form a mortar. When mixed with sand, coarse aggregate (stones or gravel), and water, cementitious materials form concrete. The terms “cementitious material,” “cementitious powder,” and “cement” can be used interchangeably.

Cement compositions can be mixtures composed of a cementitious material, for example, Portland cement, either alone or in combination with other finely-ground components such as fly ash, silica fume, blast furnace slag, limestone, natural pozzolans, or artificial pozzolans.

As used herein, the term “clinker” refers to a material made by heating limestone (calcium carbonate) with other materials (such as clay) to about 1450° C. in a kiln, to form calcium silicates and other cementitious compounds.

As used herein, the term “Portland cement” includes all cementitious compositions which meet either the requirements of the ASTM (as designated by ASTM Specification C150), or the established standards of other countries. Portland cement is prepared by sintering a mixture of components including calcium carbonate (as limestone), aluminum silicate (as clay or shale), silicon dioxide (as sand), and miscellaneous iron oxides. During the sintering process, chemical reactions take place wherein hardened nodules, commonly called clinkers, are formed. Portland cement clinker is formed by the reaction of calcium oxide with acidic components to give, primarily tricalcium silicate, dicalcium silicate, tricalcium aluminate, and a ferrite solid solution phase approximating tetracalcium aluminoferrite. The additive compositions disclosed herein are not limited to use in Portland cement and can be used with any cement composition, including blended cements.

As used herein, the term “fine aggregate” refers to particulate material used in construction whose size is less than 4.75 mm. The term “coarse aggregate” refers to particulate material used in construction that is larger than about 2/16 inch.

The expression % wt., wt. %, percent by mass, and percent by weight of a compound are synonymous and refer to the dry weight (mass) percentage of that compound. Unless otherwise specified the weight (mass) percentage of a compound being present in a composition and calculated as the weight of that compound divided by the total mass of the composition comprising the compound multiplied by 100%. The weight (mass) percentage of a compound may also refer to the wt. % of a compound added to a composition and is calculated as the weight of that compound divided by the total mass of the composition without the compound multiplied by 100%. The compositional percentages stated herein refer to the total active amounts of the alkanolamine, retarder, and accelerator chemicals, not including water, glycol, or other non-active components.

The additive compositions disclosed herein provide an enhanced strength to a cementitious composition when hydrated and set. The additive composition can also be used as a grinding aid in, for example, the process of grinding cement clinker and, therefore, can be added to a cementitious composition either just before or during a grinding process or the additive can be added to a cementitious composition prior to hydration.

The additive composition for enhancing the strength of a cementitious composition comprises an alkanolamine comprising ethanoldiisopropanolamine (EDIPA) and optionally at least one selected from the group consisting of triisopropanolamine (TIPA), diethanolisopropanolamine (DEIPA), triethanolamine (TEA), and tetrakis-(2-hydroxyethyl)ethylenediamine (THEED); at least one set retarder selected from the group consisting of a gluconate salt, sucrose, corn syrup, and molasses; and at least one set accelerator selected from the group consisting of a thiocyanate salt, sodium chloride, and calcium chloride, wherein the alkanolamine and the set accelerator are present at a mass ratio of from 0.2 to 4.0 and the set accelerator and the set retarder are present at a mass ratio of from 1 to 10.

In some embodiments, the additive composition further comprises at least one of a defoamer, a biocide, and a colorant. Defoamers are typically used to decrease the air content in a cementitious composition. Examples of defoamers that can be utilized in the present invention include, but are not limited to octyl alcohol, water insoluble esters of carbonic and boric acid, acetylenic diols, ethylene oxide-propylene oxide block or random copolymers, and silicones. Triisobutyl phosphate (TiBP) is a preferred defoamer.

In some embodiments, the additive is a liquid. The additive compositions disclosed herein may be supplied in a pure concentrated form, or diluted in aqueous or organic solvents, and may also be used in combination with other chemical admixtures.

The alkanolamine component of the additive composition disclosed here comprises ethanoldiisopropanolamine (EDIPA) as an essential element and may be present at 100% of the alkanolamine component. In embodiments, however, EDIPA is optionally mixed with other alkanolamines such as triisopropanolamine (TIPA), diethanolisopropanolamine (DEIPA), triethanolamine (TEA), and tetrakis-(2-hydroxyethyl)ethylenediamine (THEED). The alkanolamine component of the additive composition functions as a strength enhancing agent.

In embodiments, the alkanolamine component of the additive composition is a mixture of EDIPA and TIPA. In other embodiments, the alkanolamine component of the additive composition is a mixture of EDIPA and DEIPA. In embodiments where the alkanolamine comprises a mixture of EDIPA and at least one other alkanolamine, preferably the EDIPA is at least 10%, more preferably at least 20%, and most preferably at least 30% by weight of the total amount of the alkanolamine mixture. Thus, the EDIPA can be present in the additive composition of from 10% to 100%, from 10% to 50%, from 10% to 30%, from 10% to 25%, or from 10% to 20% by weight of the total amount of the alkanolamine mixture.

Preferably, the alkanolamine is present in the additive composition at from 9 to 79 mass percent, more preferably from 23.0 to 62.0 mass percent, and most preferably from 35.5 to 48.5 mass percent of the additive composition.

The set retarder component of the additive composition disclosed herein is preferably at least one selected from the group consisting of a gluconate salt, sucrose, corn syrup, and molasses. Preferably, the set retarder is present in the additive composition at from 2.0 to 46.0 mass percent, more preferably from 4 to 19.5 mass percent, and most preferably from 7.0 to 13.0 mass percent of the additive composition.

Set retarders function to prolong the setting time of the cement to allow time for the cement to be pumped into place. In some embodiments, the set retarder component of the additive composition is sodium gluconate and is present at from 50% to 100% of the set retarder component of the additive composition.

The set accelerator component of the additive composition disclosed herein functions to reduce concrete setting times. The set accelerator component of the additive composition disclosed herein is preferably at least one selected from the group consisting of a thiocyanate salt (e.g., sodium, potassium, calcium) or a chloride salt (e.g., sodium, potassium, calcium). Preferably, the set accelerator is present in the additive composition at from 16 to 77 mass percent, more preferably from 31.5 to 66.0 mass percent, and most preferably from 42.5 to 54.6 mass percent of the additive composition.

In some embodiments, the set accelerator component of the additive composition is sodium thiocyanate and is present at from 50% to 100% of the set accelerator component of the additive composition.

The additive compositions disclosed herein (and, hence, the resulting cement compositions) may also comprise additional ingredients which may be included for a desired purpose, including for example, decorative or aesthetic purposes, or to otherwise change the performance and/or one or more characteristic of the cement. For example, the aqueous compositions disclosed herein optionally comprise from about 0.1 to about 25% by weight, preferably from about 1 to 15%, more preferably from about 1 to about 10%, even more preferably from about 2 to about 8% by weight, and most preferably from about 3 to 5% by weight of at least one polyacrylic acid (“PAA”), which includes the acid, partial or complete neutralization of the acids to form salts of polyacrylic acid such as, for example, alkali metal salts and/or ammonium salts. The term “polyacrylic acid” as used herein means homopolymers of acrylic acid and copolymers of acrylic acid with an ethylenically co-polymerizable monomers such as, for example, ethylene propylene, butadiene, styrene, methacrylic acid and the like. The co-polymerizable monomers are normally present in up to 30 mole percent, preferably up to 20 mole percent. The preferred agents are homopolymers of acrylic acid and homopolymers of acrylic acid which are partially to fully neutralized with an alkali metal base, such as the sodium salt of polyacrylic acid.

The optional polyacrylic acid component of the additive composition disclosed herein preferably has a weight average molecular weight of at least about 1,500 to 500,000 g/mol weight average molecular weight as determined by gel permeation chromatography (GPC). In some embodiments, the weight average molecular weight of the polyacrylic acid polymer is in the range of from 100,000 to 500,000 g/mol. In other embodiments, the molecular weight of the polyacrylic acid polymer is in the range of from 40,000 to 100,000 g/mol. In yet other embodiments, the molecular weight of the polyacrylic acid polymer is in the range of from 1,500 to 75,000 g/mol. In still other embodiments, the weight average molecular weight of the polyacrylic acid polymer is in the range of from 1,500 to 50,000 g/mol and, preferably, from 1,500 to 25,000 g/mol. Lower molecular weights (e.g., 1,500 to 50,000 g/mol) are preferred due to cost and viscosity control of the liquid additive. When used, the polyacrylic acid functions to modify the flow properties of the resulting ground cement.

The additive composition disclosed herein provides an enhanced strength to a cement composition when hydrated, both at an early age (e.g., 1 day or 2 days) and a later age (e.g., 28 days) without significantly changing the set time of the concrete. The inventors surprisingly found that the enhanced strength at both early and late ages are not the result of the alkanolamines alone, but rather, are the result of the presence of all three components (alkanolamine, retarder, and accelerator) being present in the composition. In particular, without intending to be bound by any particular theory, it is believed that the presence of both accelerator and retarder components increases the strength without causing undesirable changes in the set times. In preferred embodiments, the alkanolamine and the set accelerator are present in the additive composition at a mass ratio of from 0.2 to 4.0 and the accelerator and the set retarder are present at a mass ratio of from 1 to 10. In more preferred embodiments, the alkanolamine and the set accelerator are present in the additive at a mass ratio of from 0.4 to 1.8 and the set accelerator and the set retarder are present at a mass ratio of from 3 to 8. In still more preferred embodiments, the alkanolamine and the set accelerator are present in the additive at a mass ratio of from 0.7 to 1.1 and the set accelerator and the set retarder are present at a mass ratio of from 4 to 6.5.

In another aspect, the present disclosure is directed to a method of enhancing the strength of a cement composition, the method comprising the steps of (i) grinding a solid comprising cement clinker in the presence of an additive thereby preparing the cement composition, or (ii) making concrete from a mixture of a solid comprising Portland cement clinker, sand, coarse aggregate, water, and an additive, wherein the additive comprises: an alkanolamine comprising ethanoldiisopropanolamine (EDIPA) and optionally at least one selected from the group consisting of triisopropanolamine (TIPA), diethanolisopropanolamine (DEIPA), triethanolamine (TEA), and tetrakis-(2-hydroxyethyl)ethylenediamine (THEED): at least one set retarder selected from the group consisting of a gluconate salt, sucrose, corn syrup, and molasses; and at least one set accelerator selected from the group consisting of a thiocyanate salt, sodium chloride, and calcium chloride, wherein the alkanolamine and the set accelerator are present at a mass ratio of from 0.2 to 4.0 and the set accelerator and the set retarder are present at a mass ratio of from 1 to 10, and wherein the cement composition, when cured, has a compressive strength at 2 days and at 28 days that is at least 10% higher than a cement composition without the additive. Preferably, the cement composition, when cured, has a compressive strength at 2 days and at 28 days that is at least from 10% to 50% higher than a cement composition without the additive.

Clinker production involves the release of CO₂ from the calcination of limestone. It is estimated that for each ton of clinker produced, up to one ton of CO₂ is released to the atmosphere. The utilization of fillers such as limestone or clinker substitutes such as granulated blast furnace slags, natural or artificial pozzolans, pulverized fuel ash, and the like, for a portion of the clinker allow a reduction on the emitted CO₂ levels per ton of finished cement. As used herein, the term filler refers to an inert material that has no later age strength enhancing attributes: the term “clinker substitute” refers to a material that may contribute to long term compressive strength enhancement beyond 28 days. The addition of these fillers or clinker substitutes to form “blended cements” is limited in practice by the fact that such addition usually results in a diminution in the physical strength properties of the resultant cement. For example, when a filler, such as limestone, is blended in amounts greater than 5%, the resultant cement exhibits a marked reduction in strength, particularly with respect to the strength attained after 28 days of moist curing (28-day strength). As used herein, the term “blended cements” refers to hydraulic cement compositions containing between 2 and 90%, more conventionally between 5 and 70%, fillers or clinker substitute materials. The additive composition disclosed herein enhances the early and later stage strength of a ground cement powder composition comprising the additive.

In some embodiments, the additive disclosed herein is used to manufacture a Type IL cement as defined by ASTM C595 (“Standard Specification for Blended Hydraulic Cements”).

In embodiments, the method disclosed herein further includes the step of adding to the cement clinker at least one supplemental cementitious material selected from the group consisting of fly ash, granulated blast furnace slag, limestone, calcined clay, and a pozzolan (inclusive of natural pozzolans and artificial pozzolans). In some embodiments, added to the clinker is at least one selected from the group consisting of limestone, fly ash, slag, and calcined clay.

In embodiments, the clinker solid to be ground with the additive disclosed herein further comprises at least 5% of added limestone by mass. In other embodiments, the clinker solid to be ground with the additive disclosed herein further comprises at least 10% of added limestone by mass. In still other embodiments, the clinker solid to be ground with the additive disclosed herein further comprises at least 20% of added limestone by mass and, more preferably, at least 22% of added limestone by mass. In still other embodiments, the clinker solid to be ground with the additive disclosed herein further comprises from 22% to 75% or more of added limestone by mass and, more preferably, from 22% to 55% of added limestone by mass. Limestone can also be added to clinker powder once the clinker has been ground such that the finished cement product can reflect the above-mentioned concentrations of added limestone.

In some embodiments, the clinker solid to be ground with the additive disclosed herein further comprises at least 4% by mass of tricalcium aluminate (C₃A). In other embodiments, the clinker solid to be ground with the additive disclosed herein further comprises from about 4% to about 20% by mass of tricalcium aluminate (C₃A).

The method includes the step of grinding with the additive composition disclosed herein. The composition as disclosed herein can be added to the clinker composition immediately prior to or during the grinding step. In one embodiment, for example, the additive composition is aqueous and can be sprayed onto the clinker composition either before, during or after grinding. In another embodiment, the additive can be sprayed onto limestone or SCM material (e.g., blast-furnace slag, fly ash, natural pozzolan, and calcined clay) that will be used to make cement or concrete, either before, during or after grinding.

In one embodiment, the additive as disclosed herein is added to the clinker in the amount of from 0.01% to 0.5% based on dry weight of the hydraulic cementitious powder. In another embodiment, the additive is present in the amount of at least 0.04% based on dry weight of the hydraulic cementitious powder. In yet another embodiment, the additive is present in the amount of at least 0.1% based on dry weight of the hydraulic cementitious powder. In still another embodiment, the additive is present in the amount of from about 0.1% to about 1.0% based on dry weight of the hydraulic cementitious powder.

In some embodiments, the additive composition comprises EDIPA. In other embodiments, the additive composition comprises a mixture of EDIPA and TIPA.

A particular advantage of the additive disclosed herein is that it may be either interground or intermixed with the cement. As used herein, the terms “interground” and “intermixed” refer to the particular stage of the cement processing in which the additives described herein are added. They may be added to the clinker during the finish grinding stage and thus interground to help reduce the energy requirements and provide a uniform free flowing cement powder with reduced tendency to form lumps during storage. It is also possible to add the subject additives as an admixture to powdered cement either prior to, in conjunction with, or after the addition of water when causing the hydraulic setting of the cement.

In embodiments, the method disclosed herein further includes the step of hydrating the cement composition by adding water.

The method of enhancing the strength of a cement composition disclosed herein increases the strength the cement composition preferably without increasing the set time of the cement by more than 35 minutes (0.58 hr.), more preferably without increasing the set time of the cement by more than 30 minutes (0.50 hr.), still more preferably without increasing the set time of the cement by more than 25 minutes (0.42 hr.), and most preferably without increasing the set time of the cement by more than 20 minutes (0.33 hr.), relative to the same cement composition without the additive.

As used herein, the term “set time” refers to the length of time between the initial mixing of the mortar or concrete and the times at which the mortar or concrete loses its ability to flow easily (initial set) and then starts to gain strength (final set). Initial set is a critical parameter for the industrial use of concrete, because concrete must remain fluid and flowable while it is transported to a job site, placed into forms, and finished. If the set time is too short, these steps cannot be completed, and the concrete may need to be discarded. On the other hand, if the final set time is too long it can cause undesirable and expensive delays in the construction process. Manipulating the amounts of accelerators and retarders in response to set time changes, however, can add expense and requires additional testing of the concrete to determine whether strength increases were sacrificed. It is preferable that the additive composition achieves a consistent balance of performance-including strength enhancement and set times—and costs to allow concrete manufacturers to accurately predict the set time of the concrete that they are making based on their previous experience with a particular cement. Therefore, it would be undesirable for a cement additive to significantly change the set time of the cement, because the cement manufacturer would then have difficulty maintaining a consistent set time of their product when starting or stopping the use of that additive, or when changing the dosage of that additive.

To measure set times, a few different methods can be used. One commonly used method is to measure the penetration of a needle into a mortar under a fixed amount of force. As the mortar sets, the penetration distance decreases allowing set times to be quantified. An example of this type of test is ASTM C 403 (Test for Time of Setting of Concrete Mixtures by Penetration Resistance). Another approach is to measure the heat output from the mortar using isothermal calorimetry. Because the increase in penetration resistance and the increase in heat output both arise from the same chemical reactions between cement and the water, the set times estimated from the two approaches will be closely correlated.

As stated above, the additive disclosed herein can be used with cement mixtures such as, for example, Portland cements, to improve the compressive strengths of the resulting mortar or concrete composition. One way to determine the compressive strength is found, for example, in ASTM C109: Standard Test Method for Compressive Strength of Hydraulic Cement Mortars. Another standard method is described in EN 196-1: Methods of testing cement. Hydrated cement compositions comprising the additives as disclosed herein have a significantly higher compressive strength, preferably a compressive strength at 2 days of at least 10% and, more preferably, at least 20% higher than the cement cured product without addition of the additive as disclosed herein and/or a compressive strength at 28 days of at least 10%, and preferably at least 15% higher than the cement cured product without addition of the additive as disclosed herein.

In yet another aspect, the present disclosure is directed to a hydraulic cement composition such as, for example, a Portland cement, comprising; from 20 to 64 percent by mass of clinker; from 5 to 60 percent by mass of calcined clay; from 0) to 35 percent by mass of limestone; from 0) to 10 percent by mass of calcium sulfate: an additive comprising: an alkanolamine comprising ethanoldiisopropanolamine (EDIPA) and optionally at least one selected from the group consisting of triisopropanolamine (TIPA), diethanolisopropanolamine (DEIPA), triethanolamine (TEA), and tetrakis-(2-hydroxyethyl)ethylenediamine (THEED); at least one set retarder selected from the group consisting of a gluconate salt, sucrose, corn syrup, and molasses; and at least one set accelerator selected from the group consisting of a thiocyanate salt, sodium chloride, and calcium chloride, wherein the alkanolamine and the set accelerator are present at a mass ratio of from 0.2 to 4.0 and the set accelerator and the set retarder are present at a mass ratio of from 1 to 10.

In addition to clinker, the hydraulic cement composition, in some embodiments, comprises at least one supplemental cementitious material chosen from ground granulated blast-furnace slag, fly ash, natural pozzolan, and calcined clay.

The hydraulic cement composition disclosed herein comprises from 20 to 64 percent by mass of clinker; from 5 to 60 percent by mass of calcined clay; from 0 to 35 percent by mass of limestone; from 0 to 10 percent by mass of calcium sulfate; and the additive as disclosed herein.

In some embodiments, the hydraulic cement composition comprises from 5% to 15% of limestone by mass. In other embodiments, the hydraulic cement composition comprises from 5% to 35% of limestone by mass. In still other embodiments, the hydraulic cement composition comprises from 20% to 35% of limestone by mass. In yet other embodiments, the hydraulic cement composition comprises at least 5% limestone by mass. In yet other embodiments, the hydraulic cement composition comprises at least 10% limestone by mass. In yet other embodiments, the hydraulic cement composition comprises at least 20% limestone by mass. In still yet other embodiments, the hydraulic cement composition comprises at least 22% limestone by mass.

In some embodiments, the hydraulic Portland cement composition further comprises at least 4% by mass of C₃A.

In embodiments, the hydraulic cement composition has a total oxide composition comprising, relative to a sum of dry weights of clinker, calcined clay, limestone, and calcium sulphate; from 5 to 25% by mass of Al₂O₃; from 25 to 55% by mass of CaO; from 20 to 40% by mass of SiO₂; from 2 to 10% by mass of SO₃; and from 0.1 to 10% by mass of Fe₂O₃.

In other embodiments, the hydraulic cement composition has a total oxide comprising, relative to a sum of dry weights of clinker, calcined clay, limestone, and calcium sulphate; from 6 to 20% by mass of Al₂O₃; from 40 to 50% by mass of CaO; from 22 to 35% by mass of SiO₂; from 2 to 5% by mass of SO₃; and from 0.5 to 8% by mass of Fe₂O₃.

In another embodiment, provided herein is a cementitious composition comprising: cement; and a means for increasing the strength of the cementitious composition upon hardening the cementitious composition in an aqueous environment without substantially increasing set time of the cementitious composition. In some embodiments, the set time is not increased by more than 35 minutes (0.58 hr), preferably not more than 30 minutes (0.50 hr), and more preferably not more than 25 minutes (0.42 hr) and, most preferably, not more than 20 minutes (0.33 hr) relative to the same cementitious composition without said means.

One skilled in the art, using the preceding detailed description, can utilize the present invention to its fullest extent. The following example are provided to illustrate the invention but should not be construed as limiting the invention in any way except as indicated in the appended claims.

### Examples

### Example 1: Screening for Effects on Strength and Set Times

The performance of an additive composition according to the present disclosure was evaluated using eight North American commercial cements, both as-received and with limestone added in the amount required to reach 22% of each of the cements. The mineral compositions of the tested cements as measured by quantitative x-ray diffraction (QXRD) are given in Table 1 for the as received cement compositions.

TABLE 1
Mineral composition of the cements (as-received)
tested for Example 1, as determined by QXRD.

| | C₃S | C₂S | C₃A | C₄AF | Limestone |
|---|---|---|---|---|---|
| Cement | (wt. %) | (wt. %) | (wt. %) | (wt. %) | (wt. %) |
| S1 | 56.6 | 11.9 | 4.8 | 9.4 | 4.8 |
| S2 | 56.1 | 16.2 | 9.6 | 4.2 | 2.6 |
| S3 | 44.8 | 21.9 | 5.0 | 6.4 | 10.8 |
| S4 | 51.8 | 18.9 | 4.5 | 8.6 | 9.7 |
| S5 | 49.4 | 18.2 | 6.9 | 4.9 | 12.0 |
| S6 | 56.7 | 16.6 | 3.4 | 9.3 | 4.9 |
| S7 | 65.3 | 9.9 | 3.1 | 8.1 | 5.0 |
| S8 | 55.7 | 11.4 | 2.6 | 8.5 | 7.9 |

To measure the compressive strengths, mortar samples were prepared and tested according to the EN 196-1 standard. For each cement, mortar samples were prepared with and without the additive composition to measure the effect on compressive strength. The compositions of the additives evaluated are provided in Table 2, wherein the composition EXP-1 represents a prior art composition as a benchmark and the composition EXP-2 represents an exemplary composition of the present invention.

TABLE 2
Composition of the Additives Evaluated (Benchmark
EXP-1) and (Inventive EXP-2).

| | | | | | | Ratios | |
|---|---|---|---|---|---|---|---|
| | Amount in formulation (wt %) | | | | | Ratio r1 | Ratio r2 |
| | | | | Sodium | Sodium | Amine/ | Accelerator/ |
| | EDIPA | DEIPA | TIPA | Gluconate | Thiocyanate | accelerator | retarder |
| EXP- | 0.00 | 6.20 | 6.21 | 10.47 | 16.50 | 0.75 | 1.58 |
| 1 | | | | | | | |
| EXP- | 8.86 | 0.00 | 12.32 | 4.92 | 23.62 | 0.90 | 4.80 |
| 2 | | | | | | | |

A goal in the development of a strength enhancing composition is the successful use of the composition over a range of cements with varying compositions. Accordingly, a performance screening was conducted using the above-identified eight North American commercial cements, both as-received and with limestone added in an amount required to reach 22% of the cement composition. For this screening, one dose of an inventive formulation EXP-2 and two doses of the benchmark EXP-1 formulation were tested. The dosages and resulting active concentrations of both additives are given in Table 3. Note that the units of ppm (parts per million) refer to the mass of additive or chemical divided by the mass of cement that is being treated.

TABLE 3
Additive dosages and concentrations of the active
chemicals for the screening experiment of the
benchmark (EXP-1) and (EXP-2) additives.

| | | Active amount at given dose (ppm) | | | | |
|---|---|---|---|---|---|---|
| | Dose | | | | Sodium | Sodium |
| | (ppm) | EDIPA | DEIPA | TIPA | Gluconate | Thiocyanate |
| EXP-1 | 1500 | 0 | 93 | 93 | 157 | 248 |
| Dose 1 | | | | | | |
| EXP-1 | 2500 | 0 | 155 | 155 | 262 | 413 |
| Dose 2 | | | | | | |
| EXP-2 | 2540 | 225 | 0 | 313 | 125 | 600 |

The parameters that were measured were the mortar strength at 1 day, 2 days, and 28 days and the initial set time. The mortar strengths were measured according to the EN 196-1 standard. Increasing the strength at different ages is the primary purpose of the disclosed additive compositions, so in all cases what is reported is the change in strength between a blank cement and the same cement made with the additive added into the mix water at the dosage given in Table 3.

### Screening Results

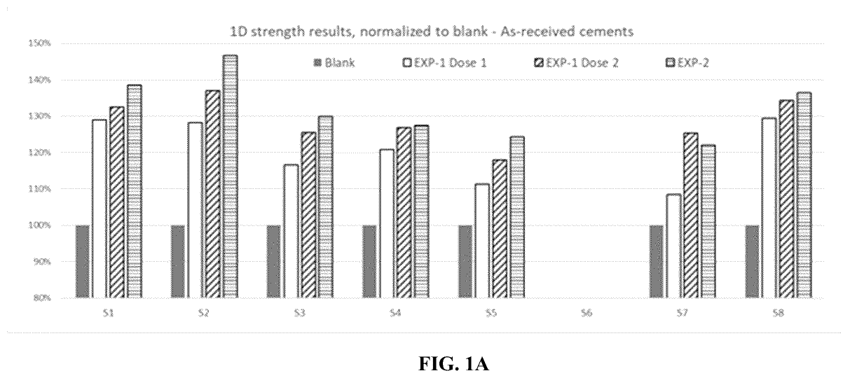

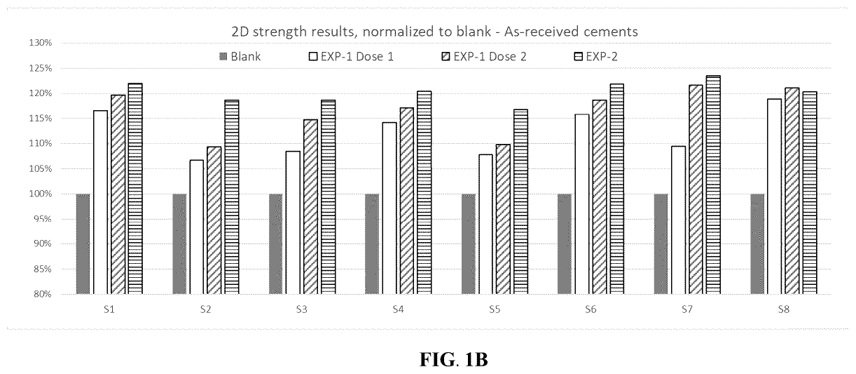

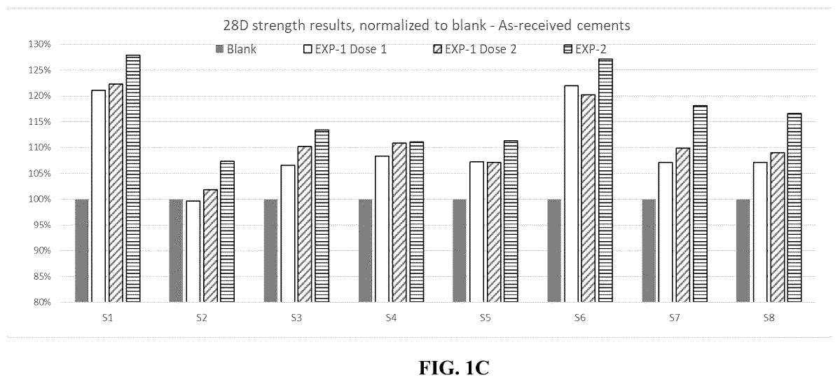

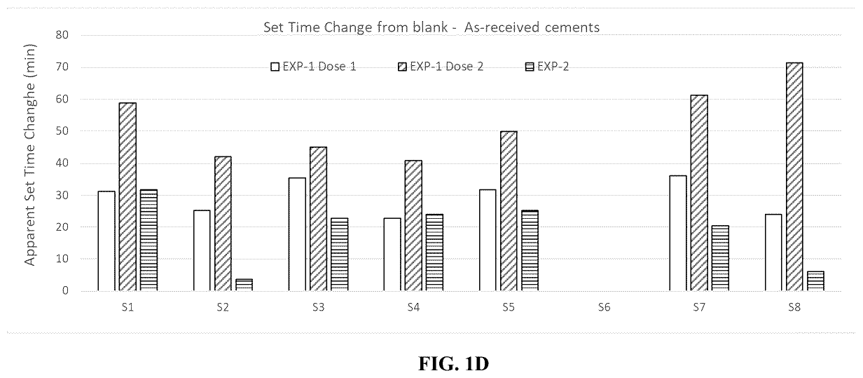

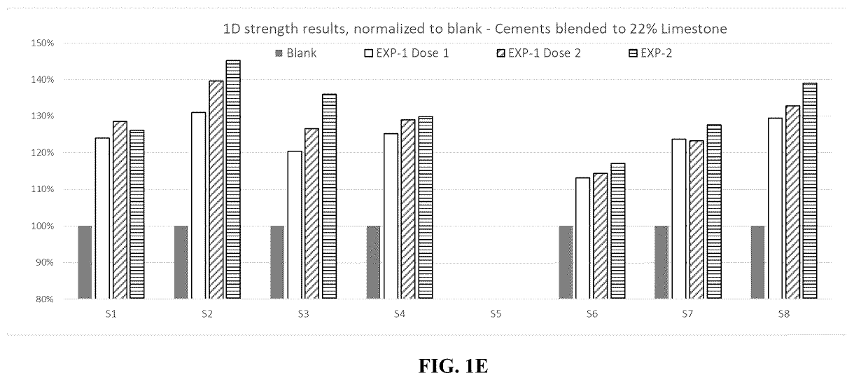

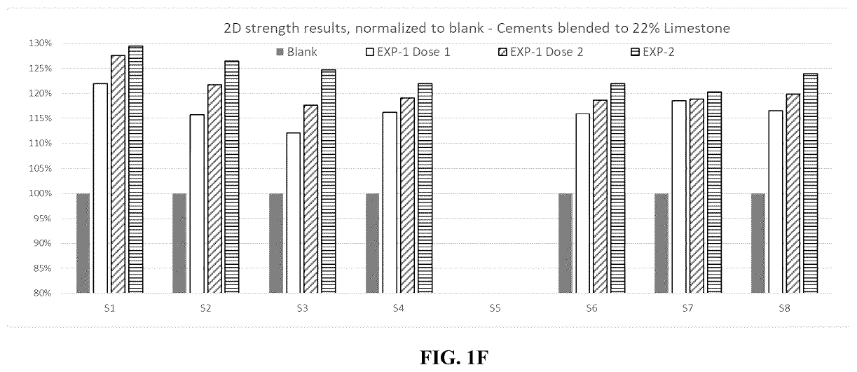

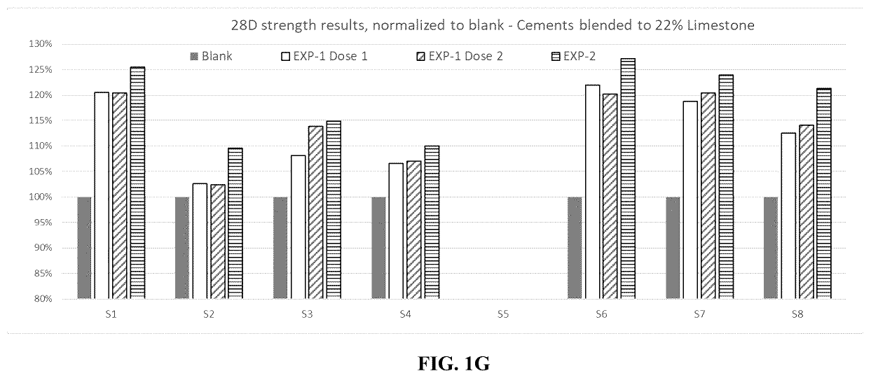

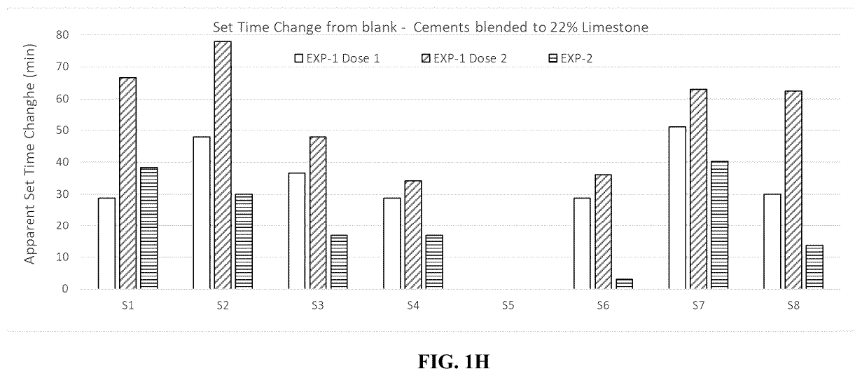

The individual performance results from the screening are shown in FIGS. 1A-1H. The average results, in terms of the change in strength and set time caused by the presence of the additives, are summarized below in Table 4.

TABLE 4
Average changes (compared to control sample with no additive)
in 1 D strength, 2 D strength, 28 D strength, and set
time from the screening of North American cements.

| | As-received cements | | | | Limestone added to 22% | | | |
|---|---|---|---|---|---|---|---|---|
| | | | | Set | | | | Set |
| | 1 D | 2 D | 28 D | time | 1 D | 2 D | 28 D | time |
| | (MPa) | (MPa) | (MPa) | (hours) | (MPa) | (MPa) | (MPa) | (hours) |
| EXP-1 | +3.88 | +3.81 | +4.48 | +0.49 | +3.76 | +4.48 | +6.51 | +0.36 |
| Dose 1 | | | | | | | | |
| EXP-1 | +5.55 | +5.33 | +6.12 | +0.88 | +4.35 | +5.49 | +7.01 | +0.92 |
| Dose 2 | | | | | | | | |
| EXP-2 | +6.22 | +6.62 | +9.18 | +0.32 | +4.99 | +6.47 | +9.45 | +0.38 |

The screening resulted in several notable differences between the performances of EXP-1 and EXP-2 in the above-identified cement compositions. The benchmark EXP-1 additive was effective at increasing strength and showed a modest dose response (higher strengths at the higher dose).

The EXP-2 additive gave higher average strengths than the higher dose of the EXP-1, and the dose response based on the change from the higher dose of EXP-1 (2500 ppm) to EXP-2 (2540) was very good, especially at 28D. This indicates that the additive EXP-2 is giving a surprisingly positive strength benefit based on its composition.

Tables 5 to 7 show the mortar strength change results at 1 day, 2 days, and 28 days, respectively.

TABLE 5
Mortar strength change results (compared to blank
with no additive) at 1 day for as-received and
limestone-supplemented commercial cements.

| | As-received cements | | | | | |
|---|---|---|---|---|---|---|
| | (MPa) | | | Limestone added to 22% | | |
| | EXP-1 | EXP-1 | | EXP-1 | EXP-1 | |
| Cement | dose 1 | dose 2 | EXP-2 | dose 1 | dose 2 | EXP-2 |
| S1 | +4.51 | +5.08 | +6.01 | +3.07 | +3.63 | +3.33 |
| S2 | +4.39 | +5.77 | +7.27 | +4.03 | +5.13 | +5.86 |
| S3 | +3.58 | +5.50 | +6.46 | +3.65 | +4.77 | +6.47 |
| S4 | +4.42 | +5.70 | +5.82 | +4.36 | +5.03 | +5.18 |
| S5 | +2.84 | +4.54 | +6.14 | — | — | — |
| S6 | — | — | — | +2.23 | +2.43 | +2.90 |
| S7 | +1.96 | +5.86 | +5.10 | +4.43 | +4.36 | +5.18 |
| S8 | +5.47 | +6.37 | +6.77 | +4.54 | +5.07 | +6.02 |
| Average | +3.88 | +5.55 | +6.22 | +3.76 | +4.35 | +4.99 |

TABLE 6
Mortar strength change results (compared to blank
with no additive) at 2 days for as-received and
limestone-supplemented commercial cements.

| | As-received cements | | | | | |
|---|---|---|---|---|---|---|
| | (MPa) | | | Limestone added to 22% | | |
| | EXP-1 | EXP-1 | | EXP-1 | EXP-1 | |
| Cement | dose 1 | dose 2 | EXP-2 | dose 1 | dose 2 | EXP-2 |
| S1 | +4.56 | +5.43 | +6.05 | +5.00 | +6.28 | +6.70 |
| S2 | +2.05 | +2.88 | +5.76 | +3.85 | +5.35 | +6.52 |
| S3 | +2.90 | +5.03 | +6.37 | +3.50 | +5.13 | +7.18 |
| S4 | +4.87 | +5.89 | +7.05 | +4.74 | +5.57 | +6.40 |
| S5 | +2.99 | +3.74 | +6.40 | — | — | — |
| S6 | — | — | — | +4.46 | +5.25 | +6.16 |
| S7 | +3.34 | +7.64 | +8.27 | +5.40 | +5.50 | +5.92 |
| S8 | +5.99 | +6.70 | +6.44 | +4.42 | +5.32 | +6.40 |
| Average | +3.81 | +5.33 | +6.62 | +4.48 | +5.49 | +6.47 |

TABLE 7
Mortar strength change results (compared to blank
with no additive) at 28 days for as-received
and limestone-supplemented commercial cements.

| | As-received cements | | | | | |
|---|---|---|---|---|---|---|
| | (MPa) | | | Limestone added to 22% | | |
| | EXP-1 | EXP-1 | | EXP-1 | EXP-1 | |
| Cement | dose 1 | dose 2 | EXP-2 | dose 1 | dose 2 | EXP-2 |
| S1 | +12.35 | +13.08 | +16.33 | +9.60 | +9.55 | +11.92 |
| S2 | −0.25 | +1.25 | +5.18 | +1.40 | +1.30 | +5.07 |
| S3 | +3.92 | +6.07 | +7.92 | +4.15 | +7.05 | +7.55 |
| S4 | +5.08 | +6.63 | +6.80 | +3.55 | +3.75 | +5.35 |
| S5 | +4.33 | +4.28 | +6.80 | — | — | — |
| S6 | — | — | — | +11.80 | +10.85 | +14.55 |
| S7 | +4.60 | +6.35 | +11.65 | +9.25 | +10.05 | +11.78 |
| S8 | +4.10 | +5.15 | +9.55 | +5.80 | +6.55 | +9.93 |
| Average | +4.88 | +6.12 | +9.18 | +6.51 | +7.01 | +9.45 |

The results of the screening show that the inventive additive composition is very effective at increasing the strength development at both early and late ages for the as-received cements and the cements with added limestone. This indicates that the EXP-2 additive will be effective at permitting higher limestone replacement levels in cements without loss of performance.

The primary compositional differences between EXP-2 and EXP-1 can be summarized as follows (see, also, Table 2): EXP-2 contains the alkanolamine EDIPA instead of DEIPA. The ratio of accelerator (sodium thiocyanate) to retarder (sodium gluconate) is higher in EXP-2 (4.80) than it is in EXP-1 (1.58). This is important for the set time stability of EXP-2 as discussed below. The importance of the ratios of the components is also discussed further below.

### Set Times

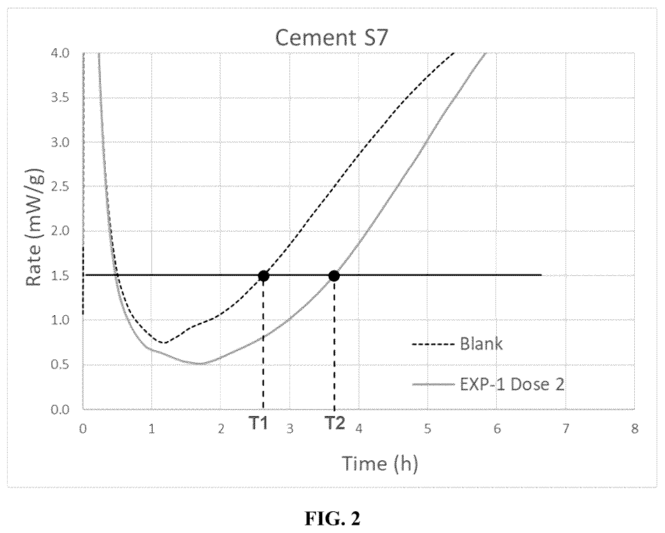

For the screening described here, a calorimetry approach was used to estimate the initial set time of the mortars made with and without the additives. For all the calorimetry results presented in this disclosure, a TAM-Air calorimeter was used, and the temperature was fixed at 21° C. The approach for estimating set time is illustrated in FIG. 2, which shows the rate of heat output (per gram of cement) from two mortar samples as a function of the time since mixing. The set time is estimated as the time required for rate of heat output to reach a fixed value of 1.5 mW/g of cement. This fixed value is shown as a horizontal line in FIG. 2. The set time estimates for the two samples are the times when the rate curves intersect this fixed horizontal line. The times are shown in FIG. 2 as time T1 (for the Blank) and T2 (for EXP-1 Dose 2).

Table 8 lists the absolute set times and the set time changes for the as-received cements S1-S8 with and without the additives EXP-1 and EXP-2.

TABLE 8
Set time results for as-received commercial cements.

| | Absolute set time (hours) | | | | Set time change (hours) | | |
|---|---|---|---|---|---|---|---|
| | | EXP-1 | EXP-1 | | EXP-1 | EXP-1 | |
| Cement | Blank | dose 1 | dose 2 | EXP-2 | dose 1 | dose 2 | EXP-2 |
| S1 | 3.44 | 3.96 | 4.42 | 3.97 | +0.52 | +0.98 | +0.53 |
| S2 | 3.70 | 4.12 | 4.40 | 3.76 | +0.42 | +0.70 | +0.06 |
| S3 | 2.34 | 2.93 | 3.09 | 2.72 | +0.59 | +0.75 | +0.38 |
| S4 | 2.47 | 2.85 | 3.15 | 2.87 | +0.38 | +0.68 | +0.40 |
| S5 | 2.77 | 3.30 | 3.60 | 3.19 | +0.53 | +0.83 | +0.42 |
| S6 | — | — | — | — | — | — | — |
| S7 | 2.61 | 3.21 | 3.63 | 2.95 | +0.60 | +1.02 | +0.34 |
| S8 | 4.22 | 4.62 | 5.41 | 4.32 | +0.40 | +1.19 | +0.10 |
| Average | 3.08 | 3.57 | 3.96 | 3.40 | +0.49 | +0.88 | +0.32 |

Table 9 lists the absolute set times and the set time changes for the as-received cements S1-S8 after the addition of powdered limestone to reach 22% limestone—with and without the additives EXP-1 and EXP-2.

TABLE 9
Set time results for commercial cements with
supplemental limestone totaling 22 wt. %.

| | Absolute set time (hours) | | | | Set time change (hours) | | |
|---|---|---|---|---|---|---|---|
| | | EXP-1 | EXP-1 | | EXP-1 | EXP-1 | |
| Cement | Blank | dose 1 | dose 2 | EXP-2 | dose 1 | dose 2 | EXP-2 |
| S1 | 3.45 | 3.93 | 4.56 | 4.09 | +0.48 | +1.11 | +0.64 |
| S2 | 3.39 | 4.19 | 4.69 | 3.89 | +0.80 | +1.30 | +0.50 |
| S3 | 2.53 | 3.14 | 3.33 | 2.81 | +0.61 | +0.80 | +0.28 |
| S4 | 2.57 | 3.05 | 3.14 | 2.85 | +0.48 | +0.57 | +0.28 |
| S5 | — | — | — | — | — | — | — |
| S6 | 3.10 | 3.58 | 3.70 | 3.15 | +0.48 | +0.60 | +0.05 |
| S7 | 2.49 | 3.34 | 3.54 | 3.16 | +0.85 | +1.05 | +0.67 |
| S8 | 4.22 | 4.72 | 5.26 | 4.45 | +0.50 | +1.04 | +0.23 |
| Average | 3.11 | 3.71 | 4.03 | 3.49 | +0.60 | +0.92 | +0.38 |

The set time increase was much less for the EXP-2 additive than for the higher dose of EXP-1 and slightly lower than that of the lower dose of EXP-1. This is a strong positive attribute, as it means that the EXP-2 additive can be used at high dosages without causing performance issues with the cement.

### Hydration Kinetics

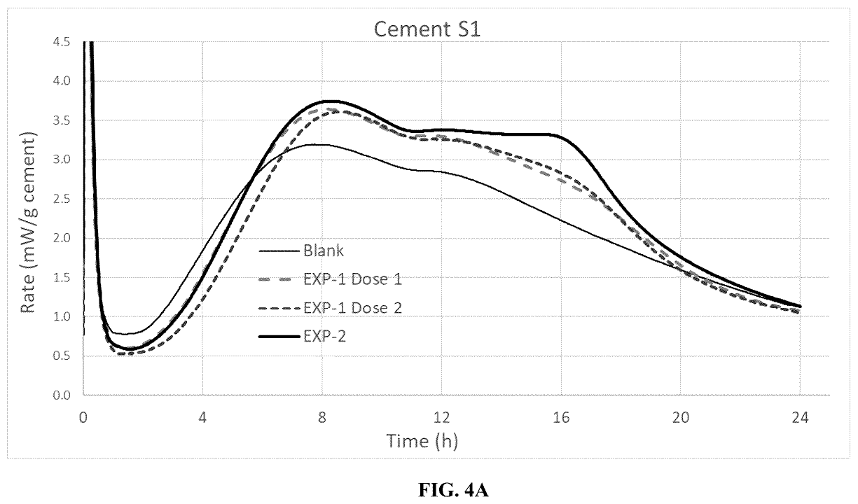

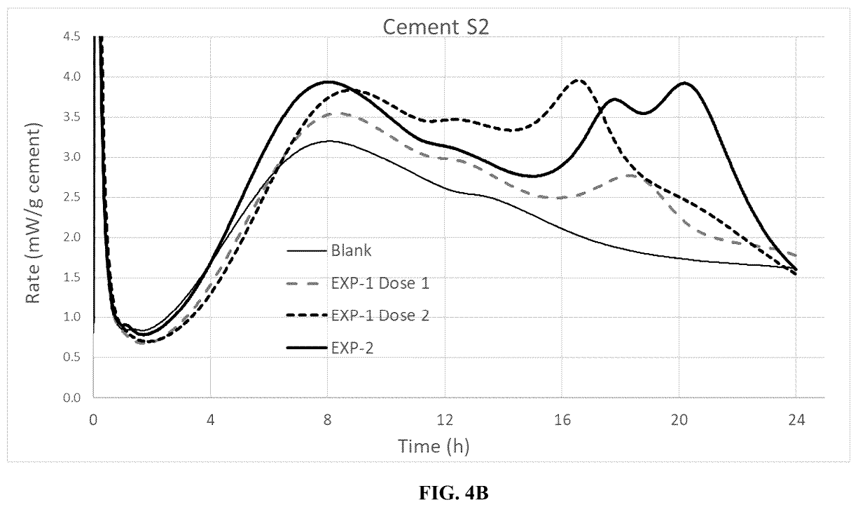

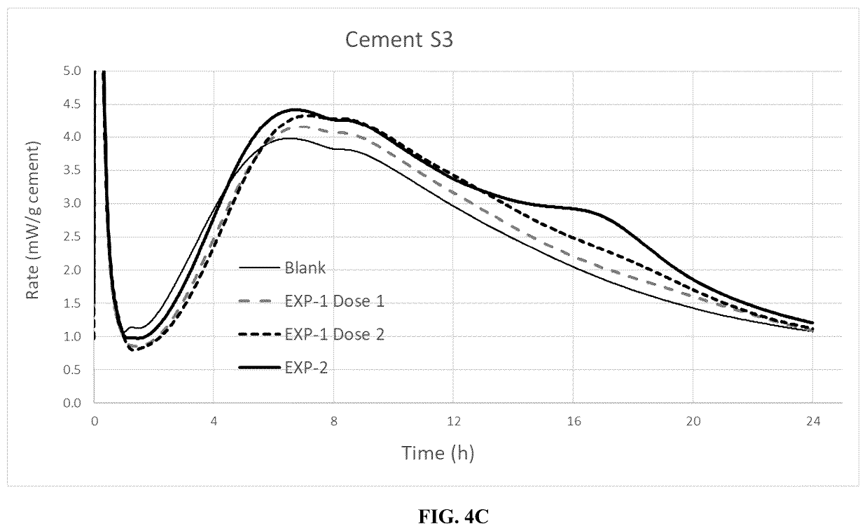

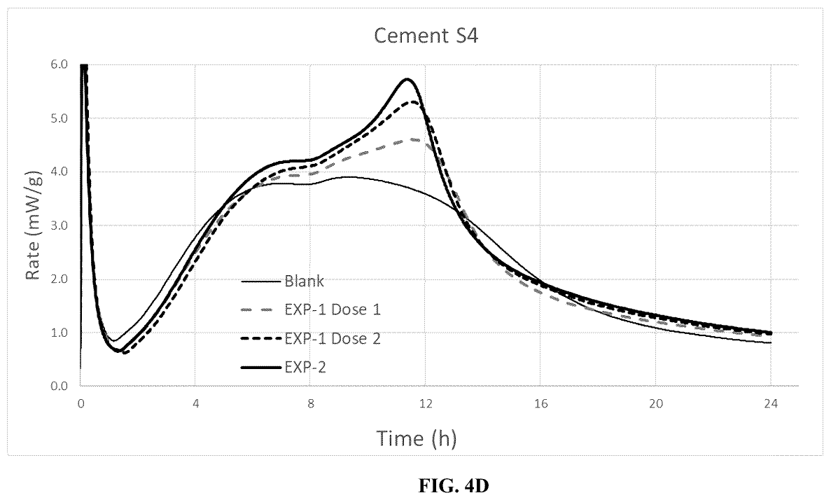

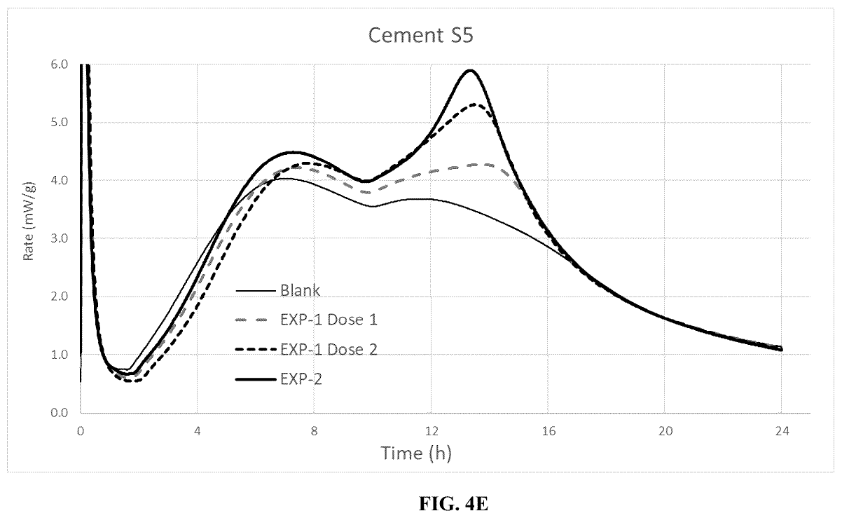

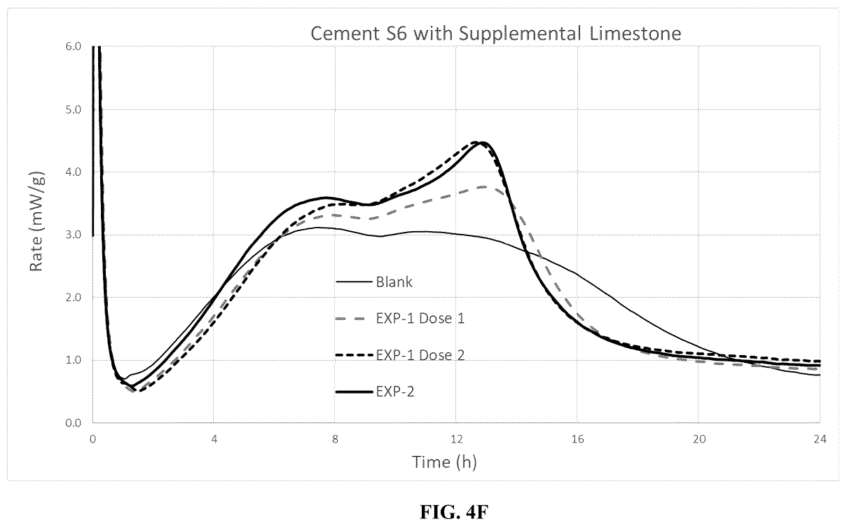

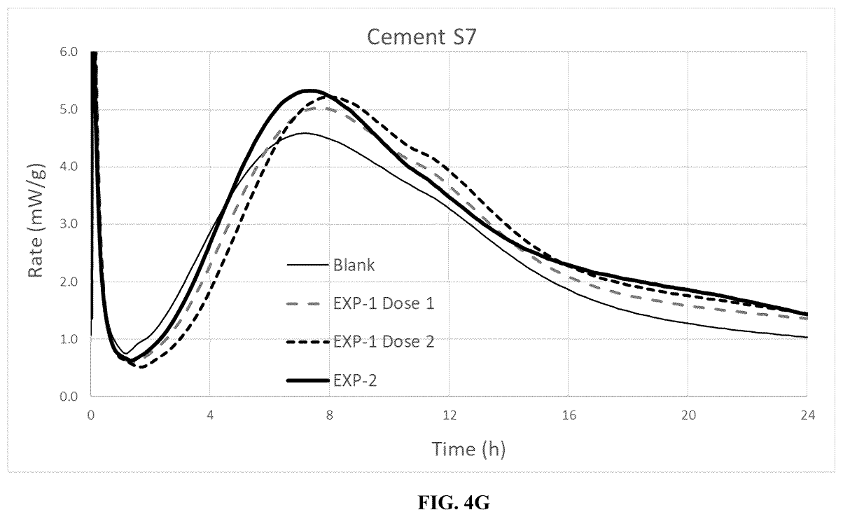

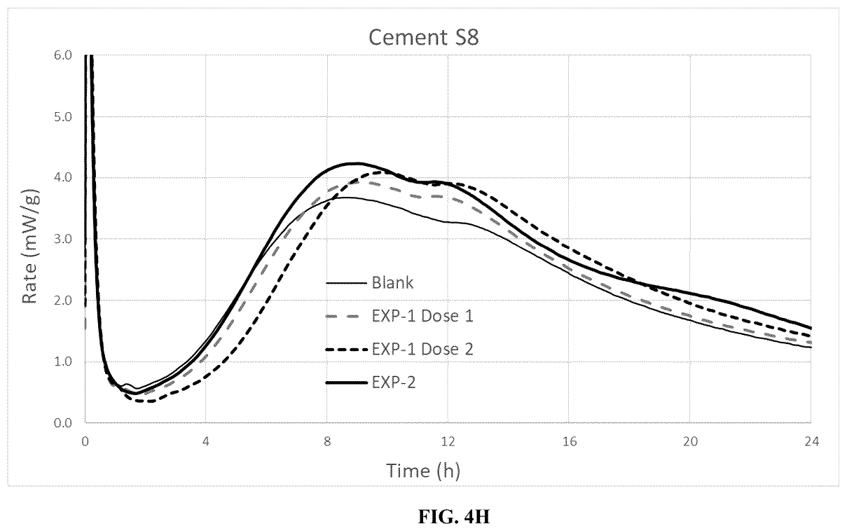

During the screening of North American cements described earlier, isothermal calorimetry was used to measure the heat release rate of the mortar samples at 21° C. As described previously, calorimetry was used to estimate the initial set time of mortars made with and without additives. Isothermal calorimetry is widely used as a way to investigate the hydration kinetics of cement at early times (usually up to a few days). The shape of the heat release curves can provide information about the cement composition, including the sulfate level. The effects of any chemical additives or admixture can also be observed. In this case, the calorimetry results reflect, to a certain extent, the previous conclusions from the screening. FIGS. 4A-4H show the calorimetry data for each of the cements tested-without an additive (“Blank”) and with the additives. The following discussion will highlight the calorimetry data from two of the screened cements, S2 and S7.

Notably, the cement S7 (FIG. 4G) from the screening did not show a large early strength difference between the benchmark EXP-1 additive and the additive EXP-2 according to the present invention. This is reflected by the similarity in the size and shape of the calorimetry curves. On the other hand, cement S2 (FIG. 4B) shows a more dramatic difference. The mortar sample made with EXP-2 has a larger secondary peak that has actually two peaks, while the sample made with EXP-1 has a single somewhat smaller secondary peak. This difference is reflected in a much larger difference in early strength for cement S2, with the EXP-2 additive giving more strength enhancement. The inventors believe that the change in the peak shape illustrated by the calorimetry plot for cement S2 is caused by the presence of EDIPA in the EXP-2 formulation, which is a key factor in its performance relative to the benchmark formulation. Thus, calorimetry may provide a useful way to determine whether an additive formulation will provide enhanced strength performance for a given cement, relative to other available formulations.

### Example 2: Importance of the Relative Proportions of Components of the Additive

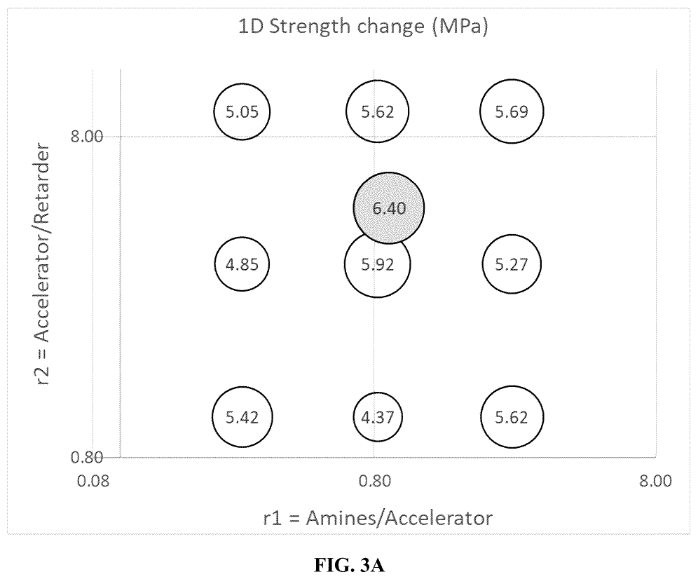

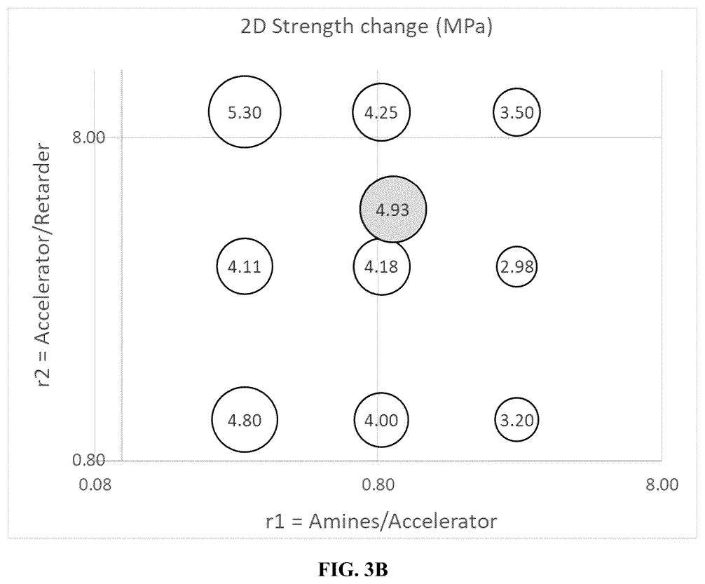

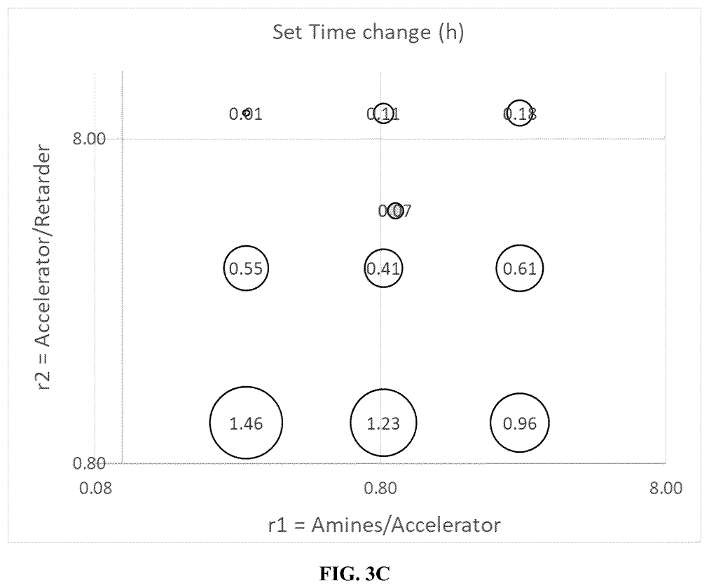

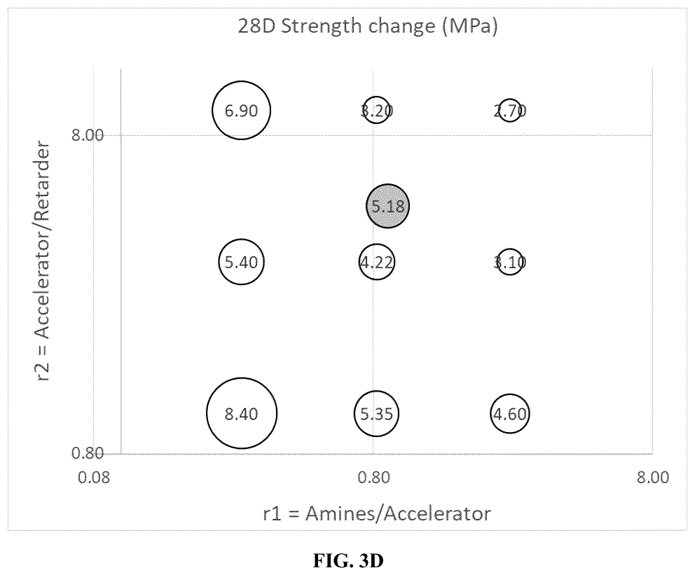

The relative mass proportions of the alkanolamine, retarder, and accelerator components of the additive compositions disclosed herein are meaningful with respect to the performance of the compositions. To illustrate this, experiments were run in which the ratios of amine/accelerator and accelerator/retarder, referred to as r1 and r2, respectively, were varied while keeping the total active concentrations of these components at a constant value of 1000 ppm. Three values of r1 (0.27, 0.82, and 2.46) and three values of r2 (1.07, 3.20, and 9.60) were tested. The amine, retarder, and accelerator chemicals were the same as for the EXP-2 additive (see Table 2). Mortar samples were made with each combination of the two ratios, as well as the ratios in the EXP-2 formulation. The results, for mortars made with cement S2, are shown in FIGS. 3A to 3D, where the size of the circle is proportional to the change from the blank and where the EXP-2 formulation is shown as a shaded circle near the center.

As can be seen in FIGS. 3A to 3D, the strength and set time changes depend strongly on the ratios of the components. The EXP-2 formulation (shaded circle) gives an optimized result of high early strength, high late strength, and minimal set time change. The EXP-1 additive is not plotted as it has a different amine chemical (DEIPA). However, the screening experiment showed that it gives less strength gain and longer set time compared to EXP-2. The results of this experiment show that the surprisingly optimal performance of the inventive EXP-2 additive arise not only from its individual chemical components, but also from the specific balance of these components within the formulation.

### Example 3: Strength Testing

A sample of industrial cement from a plant in North America manufactured using a glycol-based additive with no strength enhancing chemicals was used for this testing. Mortar strength testing was performed following the ASTM C109 standard using additive compositions according to the present disclosure. The additive compositions tested are shown in Table 10. All additives contain alkanolamine, accelerator, and retarder components. Additive A contains a mixture of DIEPA and TIPA as the alkanolamine component and was used at two dosages. Additives B, C, and D contain EDIPA as the alkanolamine component.

TABLE 10
Composition of the additives used for Example
2 in ppm (mass of chemical per mass of cement).

| | | A | A | | | |
|---|---|---|---|---|---|---|
| | | (low | (high | | | |
| Additive | Type | dose) | dose) | B | C | D |
| DIEPA | Amine | 83 | 152 | | | |
| TIPA | Amine | 83 | 152 | | | |
| EDIPA | Amine | | | 164 | 164 | 164 |
| Sodium Gluconate | Retarder | 59 | 109 | 109 | | |
| Corn Syrup | Retarder | | | | 60 | 60 |
| Sodium | Accelerator | 248 | 456 | 456 | 325 | 236 |
| Thiocyanate | | | | | | |
| Total actives | | 472 | 870 | 729 | 549 | 460 |

The strength results are given in Table 11. All of the additives increased strength significantly. However, the additive compositions with EDIPA (additives B, C, and D) performed better than additive compositions containing DEIPA and TIPA, even when the dosage of Additive A was higher. For example, Additive D, with 460 ppm of active chemicals, gives +17% and +10% at 1D and 28d, respectively, while the high dose of additive A (870 ppm active chemicals) gives +14% and +7% at 1D and 28D, respectively. This illustrates the particular advantage of using EDIPA in the disclosed additive formulations.

TABLE 11
Strength results for Example 3, showing the increase in strength
at two ages compared to a control mortar with no additive.

| Additive | 1 D | 28 D |
|---|---|---|
| A (low dose) | +10% | +8% |
| A (high dose) | +14% | +7% |
| B | +17% | +10% |
| C | +19% | +10% |
| D | +17% | +10% |

While this invention has been particularly shown and described with references to example embodiments thereof, it will be understood by those skilled in the art that various changes in form and details may be made therein without departing from the scope of the invention encompassed by the appended claims.

1. A composition for use as an additive for enhancing the strength of a cementitious composition, the composition comprising:
an alkanolamine comprising ethanoldiisopropanolamine (EDIPA) and optionally at least one selected from the group consisting of triisopropanolamine (TIPA), diethanolisopropanolamine (DEIPA), triethanolamine (TEA), and tetrakis-(2-hydroxyethyl)ethylenediamine (THEED);
at least one set retarder selected from the group consisting of a gluconate salt, sucrose, corn syrup, and molasses; and
at least one set accelerator selected from the group consisting of a thiocyanate salt, sodium chloride, and calcium chloride,
wherein the alkanolamine and the set accelerator are present at a mass ratio of from 0.2 to 4.0 and the set accelerator and the set retarder are present at a mass ratio of from 1 to 10.

2. The composition of claim 1 wherein the alkanolamine and the set accelerator are present at a mass ratio of from 0.4 to 1.8 and the set accelerator and the set retarder are present at a mass ratio of from 3 to 8.

3. The composition of claim 2 wherein the alkanolamine and the set accelerator are present at a mass ratio of from 0.7 to 1.1 and the set accelerator and the set retarder are present at a mass ratio of from 4 to 6.5.

4. The composition of claim 1 wherein the alkanolamine comprises EDIPA and THEED.

5. The composition of claim 1 further comprising from about 2 to about 8% by weight of at least one polyacrylic acid.

6. The composition of claim 1 wherein the alkanolamine is present at from 35.5 to 48.5 mass percent, the set accelerator is present at from 42.5 to 54.6 mass percent, and the set retarder is present at from 7.0 to 13.0 mass percent.

7. The composition of claim 1 wherein the alkanolamine comprises a mixture of EDIPA and TIPA.

8. The composition of claim 1 wherein EDIPA is at least 30% of the total amount of alkanolamine.

9. The composition of claim 1 further comprising water.

10. A method of enhancing the strength of a cement composition, the method comprising the steps of:
(i) grinding a solid comprising Portland cement clinker in the presence of an additive thereby preparing the cement composition, or
(ii) making concrete from a mixture of a solid comprising Portland cement, sand, coarse aggregate, water, and an additive,
wherein the additive comprises:
an alkanolamine comprising ethanoldiisopropanolamine (EDIPA) and optionally at least one selected from the group consisting of triisopropanolamine (TIPA), diethanolisopropanolamine (DEIPA), triethanolamine (TEA), and tetrakis-(2-hydroxyethyl)ethylenediamine (THEED);
at least one set retarder selected from the group consisting of a gluconate salt, sucrose, corn syrup, and molasses; and
at least one set accelerator selected from the group consisting of a thiocyanate salt, sodium chloride, and calcium chloride,
wherein the alkanolamine and the set accelerator are present at a mass ratio of from 0.2 to 4.0 and the set accelerator and the set retarder are present at a mass ratio of from 1 to 10, and wherein the cement composition, when cured, has a compressive strength at 2 days and at 28 days that is at least 10% higher than a cement composition without the additive.

11. The method of claim 10 wherein the alkanolamine and the set accelerator are present at a mass ratio of from 0.7 to 1.1 and the set accelerator and the set retarder are present at a mass ratio of from 4 to 6.5.

12. The method of claim 10 wherein the alkanolamine is EDIPA and THEED.

13. The method of claim 12 wherein the alkanolamine is present at from 23.0 to 62.0 mass percent, the set accelerator is present at from 31.5 to 66.0 mass percent, and the set retarder is present at from 4.0 to 19.5 mass percent.

14. The method of claim 10 wherein the alkanolamine is present at from 35.5 to 48.5 mass percent, the set accelerator is present at from 42.5 to 54.6 mass percent, and the set retarder is present at from 7.0 to 13.0 mass percent.

15. The method of claim 10 wherein the alkanolamine comprises a mixture of EDIPA and TIPA.

16. The method of claim 12 wherein EDIPA is at least 30% of the total amount of alkanolamine.

17. The method of claim 10 wherein the solid further comprises at least one selected from the group consisting of limestone, fly ash, slag, pozzolan, and calcined clay.

18. The method of claim 10 wherein the solid further comprises at least 22% limestone by mass.

19. A strength-enhanced hydraulic cement powder composition comprising cement and the additive composition of claim 1.

20. The composition of claim 19 wherein the alkanolamine and the set accelerator are present at a mass ratio of from 0.4 to 1.8 and the set accelerator and the set retarder are present at a mass ratio of from 3 to 8.

21. The composition of claim 19 wherein the cement powder comprises at least 22% limestone by mass.

22. The composition of claim 19 wherein the cement powder comprises at least one selected from the group consisting of ground granulated blast-furnace slag, fly ash, a pozzolan, and calcined clay.

23. The composition of claim 19 wherein the cement powder composition has a set time that is not increased by more than 35 minutes relative to the same cement powder composition without the additive.

24. The method of claim 12 wherein the cement composition has a set time that is not increased by more than 25 minutes relative to the same cement composition without the additive.
